(19) United States
(12) Patent Application Publication
(10) Pub. No.: US 2025/0369706 A1
(43) Pub. Date: Dec. 4, 2025

(54) HEAT EXCHANGER AND METHOD FOR PRODUCING HEAT EXCHANGER

(71) Applicant: Resonac Corporation, Tokyo (JP)

(72) Inventors: Nobuyuki TAKAHASHI, Tokyo (JP); Hayato SAITO, Tokyo (JP)

(73) Assignee: Resonac Corporation, Tokyo (JP)

(21) Appl. No.: 18/875,255

(22) PCT Filed: Nov. 15, 2023
(86) PCT No.: PCT/JP2023/041039

§ 371 Date: Dec. 16, 2024

(30) Foreign Application Priority Data
Dec. 23, 2022 (JP) 2022-207133

(51) Int. Cl. F28F 3/12; F28F 21/08

(52) U.S. Cl. CPC F28F 3/12; F28F 21/089

(57) ABSTRACT

The method for producing a heat exchanger includes: a before-joining step in which prepared is a stack in which a surface sheet, a solid joining material comprising, as a main component, an amorphous thermoplastic resin which is at least one resin selected from among thermoplastic epoxy resins and phenoxy resins, and a channel formation sheet having a channel in a surface thereof facing the surface sheet have been arranged in this order; and a joining step in which the stack is heated and pressed to melt the solid joining material and join the surface sheet to the channel formation sheet. The amorphous thermoplastic resin has an epoxy equivalent of 1,600 or greater, or the amorphous thermoplastic resin contains no epoxy group and has a heat of fusion of 15 J/g or less.

### TECHNICAL FIELD

The present disclosure relates to a heat exchanger and a method for manufacturing a heat exchanger.

### BACKGROUND ART

In a battery module to be mounted on an electric vehicle or a hybrid vehicle, the amount of heat generated by a battery pack is large in order to continuously charge or discharge a large capacity. For this reason, a technique has been proposed in which a water-cooled chiller or a heat pipe is incorporated in the battery module to avoid adverse effects due to heat.

For example, Patent Literature 1 discloses a heat exchanger in which two or more etched metal sheets are stacked to form a container whose at least a part of an outer peripheral portion is sealed by joining.

### CITATION LIST

### Patent Literature

PTL 1: JP 2015-059693 A

### SUMMARY OF INVENTION

### Technical Problem

In the heat exchanger of Patent Literature 1 described above, the outer peripheral wall and the wick forming the flow path are sealed by diffusion joining, and hence there is a problem that the degree of difficulty is high and it is difficult to improve production efficiency.

In the present disclosure, the joining process time means a time from a start point to an end point, the start point being a time when a joining agent first comes into contact with one or both of base materials constituting a joined body, and the end point being a time when the preparation of the joined body is completed. For example, the joining process time includes a time required for application and drying of a liquid adhesive or placement of a solid joining agent, and a time required for bonding the base materials to each other (e.g., curing an adhesive layer). The shorter the joining process time, the higher the productivity of the joined body.

In the present disclosure, the open time means a time limit from when the joining agent is applied or placed on one of the base materials (e.g., a first member) to when placement of the other base material (e.g., a second member) is completed. Within the open time, the adhesive force of the joining agent is not decreased, and these base materials can be bonded to each other with a sufficient adhesive force. The longer the open time, the higher the flexibility in the manufacturing process of the joined body.

An object of the present invention is to provide a method for manufacturing a heat exchanger capable of further improving productivity, more specifically, having a short joining process time and a long open time. Another object of the present invention is to provide a heat exchanger whose constituent members are joined with high joining strength.

### Solution to Problem

The present disclosure includes the following aspects.

[1]

A method for manufacturing a heat exchanger, including:
a pre-joining process of preparing a laminated body in a state in which a surface sheet, a solid joining agent containing, as a main component, an amorphous thermoplastic resin that is at least one type of agent selected from the group consisting of a thermoplastic epoxy resin and a phenoxy resin, and a flow path forming sheet having a flow path on a surface facing the surface sheet, are arranged in this order; and
a joining process of joining the surface sheet and the flow path forming sheet by heating and pressurizing the laminated body to melt the solid joining agent, in which
an epoxy equivalent of the amorphous thermoplastic resin is 1600 or more or the amorphous thermoplastic resin does not contain an epoxy group, and heat of fusion of the amorphous thermoplastic resin is 15 J/g or less.
   [2]

The method for manufacturing a heat exchanger according to [1], in which the heating and pressurizing are performed under conditions of 100° C. to 400° C. and 0.01 MPa to 20 MPa.

[3]

The method for manufacturing a heat exchanger according to [1] or [2], in which the solid joining agent before melting has a shape selected from the group consisting of a film, a rod, a pellet, and a powder.

[4]

The method for manufacturing a heat exchanger according to any one of [1] to [3], in which materials of the surface sheet and the flow path forming sheet are metals.

[5]

A heat exchanger including: a surface sheet; a flow path forming sheet; and an adhesive layer joining the surface sheet and the flow path forming sheet, in which the adhesive layer contains a solid joining agent containing, as a main component, an amorphous thermoplastic resin that is at least one type of agent selected from the group consisting of a thermoplastic epoxy resin and a phenoxy resin, an epoxy equivalent of the amorphous thermoplastic resin is 1,600 or more or the amorphous thermoplastic resin does not contain an epoxy group, and heat of fusion of the amorphous thermoplastic resin is 15 J/g or less.

[6]

The heat exchanger according to [5], in which materials of the surface sheet and the flow path forming sheet are metals.

[7]

The heat exchanger according to [5] or [6], in which:
the surface sheet has an inlet and an outlet, and the flow path forming sheet has a flow path on a surface facing the surface sheet;
the flow path includes
an inlet corresponding portion connected to the inlet, and an outlet corresponding portion connected to the outlet, and
a plurality of intersecting paths extending in a direction intersecting a direction connecting the inlet corresponding portion and the outlet corresponding portion;
the surface sheet and the flow path forming sheet are joined to each other by welding so as to surround an outer side of the flow path; and
the adhesive layer is provided at at least one of positions along the plurality of intersecting paths.
   [8]

The heat exchanger according to [7], in which
the surface sheet includes a first surface sheet and a second surface sheet;
the flow path penetrates the flow path forming sheet in a thickness direction;
in order of, the first surface sheet, the flow path forming sheet, and the second surface sheet are sequentially provided in a thickness direction; and
the inlet and the outlet are provided in the first surface sheet.
   [9]

The heat exchanger according to [7], in which
the surface sheet includes a first surface sheet and a second surface sheet;
the flow path penetrates the flow path forming sheet in a thickness direction;
in order of, the first surface sheet, the flow path forming sheet, and the second surface sheet are sequentially provided in a thickness direction; and
the inlet is provided in the first surface sheet, and the outlet is provided in the second surface sheet.

### Advantageous Effects of Invention

According to the method for manufacturing a heat exchanger of the present disclosure, the productivity of the heat exchanger can be further improved, more specifically, the heat exchanger can be manufactured in a short joining process time and with a long open time, and the constituent members can be joined to each other with high joining strength.

### BRIEF DESCRIPTION OF DRAWINGS

FIG. 1 is a perspective view of a heat exchanger according to an embodiment.

FIG. 2 is an exploded perspective view of the heat exchanger according to the embodiment.

FIG. 3 is a plan view of a flow path forming sheet provided with a solid joining agent.

FIG. 4 is a plan view of a heat exchanger according to a modified example 1.

FIG. 5 is an exploded perspective view of a heat exchanger according to a modified example 2.

FIG. 6 is a schematic cross-sectional view of a state in which a first member and a second member are joined to each other via an adhesive layer containing a solid joining agent.

### DESCRIPTION OF EMBODIMENTS

Hereinafter, embodiments of the present disclosure will be described in detail with reference to the drawings. The present disclosure is not limited to the following embodiments, and can be variously modified within the scope of the present invention.

In the following description, an X-direction, a Y-direction, and a Z-direction of an orthogonal coordinate system are defined as follows. The Z-direction (third direction) is the thickness direction of a heat exchanger. The X-direction (first direction) and the Y-direction (second direction) are plane directions of a heat exchanger, and are the longitudinal direction and the short side direction when the shape of the heat exchanger in a plan view is rectangular.

“Along” a certain reference includes being along a direction within a range of less than ±45° with respect to the certain reference. The end portion, in a certain direction, of a certain member or the like refers to a portion of the member or the like, the portion starting from the end edge, in the certain direction, thereof and extending over a length of up to ⅕ (preferably 1/10) of the entire length, in the certain direction, of the member or the like.

In the present disclosure, joining means connecting objects to each other, and adhesion and welding are subordinate concepts thereof. Adhesion means that two adherends (objects to be adhered) are brought into a joined state via an organic material (curable resin, thermoplastic resin, or the like) such as a tape or an adhesive. Welding means that a surface of a thermoplastic resin or the like is melted by heat and is joined by using entanglement and crystallization due to molecular diffusion that are created during the course of contact pressurization and cooling, or using molecular interactions with a base material that is created during melting.

### [Heat Exchanger]

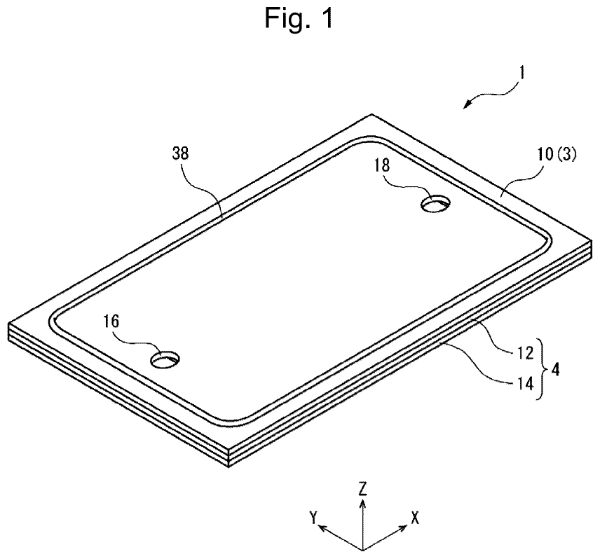

A heat exchanger 1 of an embodiment illustrated in FIG. 1 is a rectangular plate-shaped member having a plane (hereinafter, also referred to as an “XY plane”) parallel to the X-direction and the Y-direction orthogonal to the Z-direction, and includes a surface sheet 3, a flow path forming sheet 4, and an adhesive layer (not illustrated in this view) for joining the surface sheet 3 and the flow path forming sheet 4. In the following description, the heat exchanger may be referred to as a “joined body”, the surface sheet as a “first member”, and the flow path forming sheet as a “second member”.

In the present embodiment, the heat exchanger 1 includes a first surface sheet 10 as the surface sheet 3, and an intermediate sheet 12 and a second surface sheet 14 as the flow path forming sheet 4. The first surface sheet 10, the intermediate sheet 12, and the second surface sheet 14, are arranged in this order in the Z-direction, and the surfaces facing each other are joined to each other by the adhesive layers. The heat exchanger 1 illustrated in FIG. 1 is a rectangular plate-shaped member whose longitudinal direction is the X-direction and short side direction is the Y-direction.

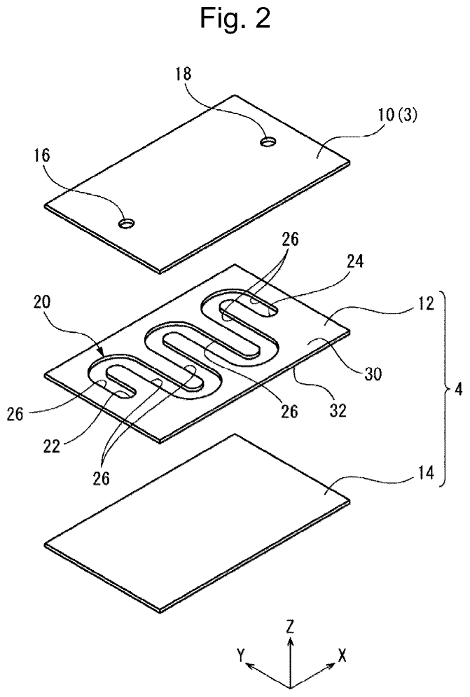

As illustrated in FIG. 2, a plate-shaped member having a thickness of 0.5 mm to 3 mm can be used as the first surface sheet 10, and the first surface sheet 10 has an inlet 16 and an outlet 18 penetrating in the Z-direction. The inlet 16 and the outlet 18 are formed at positions separated from each other in the X-direction. That is, the inlet 16 is formed at one end portion, in the X-direction, of the first surface sheet 10, and the outlet 18 is formed at the other end portion, in the X-direction, of the first surface sheet 10. The material of the first surface sheet 10 is metal or resin, and is preferably metal.

A plate-shaped member having a thickness of 1.0 mm to 5 mm can be used as the intermediate sheet 12, and the intermediate sheet 12 has a flow path 20. The flow path 20 is a groove having a predetermined width. The flow path 20 penetrates the intermediate sheet 12 in the Z-direction. The flow path 20 has an inlet corresponding portion 22 and an outlet corresponding portion 24. The inlet corresponding portion 22 is arranged at one end portion, in the X-direction, of the intermediate sheet 12, and the outlet corresponding portion 24 is arranged at the other end portion, in the X-direction, of the intermediate sheet 12. The inlet corresponding portion 22 is formed at a position corresponding to the inlet 16 of the first surface sheet 10, and the outlet corresponding portion 24 is formed at a position corresponding to the outlet 18 of the first surface sheet 10.

The flow path 20 has a plurality of intersecting paths 26 extending in a direction intersecting a direction connecting the inlet corresponding portion 22 and the outlet corresponding portion 24. In the present embodiment, the direction connecting the inlet corresponding portion 22 and the outlet corresponding portion 24 is parallel to the X-direction. The flow path 20 has a plurality of (six in FIG. 1) intersecting paths 26 extending in the Y-direction. The plurality of intersecting paths 26 are arranged at predetermined intervals in the X-direction. The flow path 20 has a zigzag shape in which a portion between the inlet corresponding portion 22 and the outlet corresponding portion 24 is alternately bent on both sides in the Y-direction. The flow path 20 is closed on its one side in the Z-direction by the first surface sheet 10 and on its the other side in the Z-direction by the second surface sheet 14. In this way, the flow path 20 is formed so that a refrigerant (not illustrated) can circulate from the inlet corresponding portion 22 to the outlet corresponding portion 24. The material of the intermediate sheet 12 is metal or resin, and is preferably metal. The material of the intermediate sheet 12 may be the same as or different from that of the first surface sheet 10.

As the second surface sheet 14, a plate-shaped member having a thickness of 0.5 mm to 3 mm can be used, and the material may be the same as or different from those of the first surface sheet 10 and the intermediate sheet 12.

The metal is preferably at least one type of material selected from the group consisting of aluminum, iron, copper, magnesium, and alloys thereof. From the viewpoint of adhesive force and strength of the base material and from the viewpoint of strength of the interfacial adhesive force with the solid joining agent, the metal is more preferably at least one type of material selected from the group consisting of aluminum, an aluminum alloy, and an iron alloy, and is even more preferably at least one type of material selected from the group consisting of aluminum and an aluminum alloy having excellent heat radiation efficiency.

The resin is preferably one type of agent selected from the group consisting of a thermoplastic resin, a thermosetting resin, and a fiber-reinforced plastic (FRP), and is more preferably a thermoplastic resin from the viewpoint of adhesive force, cost, and ease of molding.

A high adhesive force can be obtained by subjecting the surface sheet 3 or the flow path forming sheet 4, or both, to a suitable pretreatment. As the pretreatment, a pretreatment for cleaning the surface of the base material or a pretreatment for forming irregularities on the surface is preferable. The pretreatment may be performed singly or in combination of two or more thereof. As specific methods of these pretreatments, known methods can be used.

Specifically, when the material of the member is aluminum, glass, ceramic, or iron, at least one type of treatment selected from the group consisting of degreasing treatment, UV ozone treatment, blasting treatment, polishing treatment, plasma treatment, and etching treatment is preferable. When the material of the member is FRP, polypropylene, polycarbonate, polymethyl methacrylate, polyetherimide, polyamide, or polybutylene terephthalate, at least one type of treatment selected from the group consisting of degreasing treatment, UV ozone treatment, blasting treatment, polishing treatment, plasma treatment, and corona discharge treatment is preferable.

The heat exchanger 1 according to one embodiment can be manufactured by a manufacturing method including a pre-joining process and a joining process. In the pre-joining process, a laminated body in a state in which the surface sheet 3, the solid joining agent, and the flow path forming sheet 4 are arranged in this order is prepared. In the laminated body in the present embodiment, the first surface sheet 10, the solid joining agent, the intermediate sheet 12, the solid joining agent, and the second surface sheet 14, are arranged in this order.

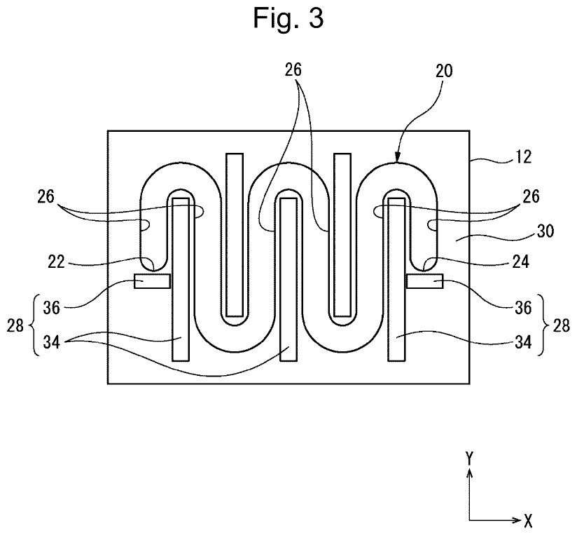

As illustrated in FIG. 3, a solid joining agent 28 has a strip shape and is arranged along the intersecting path 26. The solid joining agent 28 is arranged on each of a first surface 30 facing, the first surface sheet 10, and a second surface 32, facing the second surface sheet 14, of the intermediate sheet 12. Since the solid joining agent 28 is arranged at the same positions on the first surface 30 and the second surface 32, the first surface 30 will only be described.

The solid joining agent 28 illustrated in FIG. 3 includes a first solid joining agent 34 and a second solid joining agent 36. The first solid joining agent 34 extends along the intersecting path 26 and is arranged between the adjacent intersecting paths 26. The second solid joining agent 36 extends in the X-direction and is arranged on the outer side of the flow path 20 from the terminal end of each of the inlet corresponding portion 22 and the outlet corresponding portion 24. The solid joining material 28 is arranged on the inner side in the XY plane from the outer peripheral portion surrounding the outside of the flow path 20. The outer peripheral portion has a predetermined width from the outer edge of the intermediate sheet 12 to the inner in the XY plane. The outer edge of the outer peripheral portion is the outer edge of the intermediate sheet 12, and the inner edge of the outer peripheral portion is located on the outside in the XY plane from the outer edge of the flow path 20.

In the joining process, the laminated body is heated and pressurized under predetermined conditions to melt the solid joining agent 28. Thereafter, the temperature is lowered to solidify the solid joining agent 28, whereby the solid joining agent 28 serves as the adhesive layer. The heat exchanger 1 can be manufactured by joining the first surface sheet 10, the intermediate sheet 12, and the second surface sheet 14 in this way. Compared to the known case where the intersecting paths are joined by diffusion joining, the heat exchanger 1 can reduce the number of processes by joining using the solid joining agent 28, so that productivity can be further improved.

In the heat exchanger 1, the surface sheet 3 and the flow path forming sheet 4 are continuously joined at the end portion in the X-direction and the end portion in the Y-direction. In the case of the present embodiment, the heat exchanger 1 has a welded part 38 at the outer peripheral portion located at a position surrounding the outside of the flow path 20 (FIG. 1). In the case of the present embodiment, the welded part 38 joins the first surface sheet 10 and the intermediate sheet 12, and the intermediate sheet 12 and the second surface sheet 14, by welding, respectively. The welded part 38 has a rectangular shape along the outer edge of the heat exchanger 1 as viewed from the Z-direction, and is continuously formed. The welding is not particularly limited, and laser welding, resistance welding, ultrasonic welding, or the like is applied.

Although not illustrated, the heat exchanger 1 has pipes connected to the inlet 16 and the outlet 18, respectively, and the refrigerant is supplied from a cooling system through the pipe connected to the inlet 16. The refrigerant flows into the heat exchanger 1 from the inlet 16, flows along the flow path toward the outlet 18, and returns into the cooling system from the outlet 18. The outer periphery of the heat exchanger 1 is sealed by welding, so that the refrigerant is prevented from flowing out to the outside. The refrigerant comes into contact with the first surface sheet 10 and the second surface sheet 14 in the flow path 20 to exchange heat with the outside via the first surface sheet 10 and the second surface sheet 14. The refrigerant is heated and expanded by the heat received from the outside. When the refrigerant expands, the internal pressure of the heat exchanger 1 rises. Since the heat exchanger 1 is joined along the intersecting path 26 by the adhesive layer, deformation in the Z-direction is suppressed. Since the deformation, in the Z-direction, of the heat exchanger 1 is suppressed, the refrigerant flowing through the heat exchanger 1 more reliably comes into contact with the inner surfaces of the first surface sheet 10 and the second surface sheet 14, and flows to the outlet 18 while changing its direction in a zigzag manner in the Y-direction along the flow path 20. Therefore, the heat exchanger 1 can exchange heat with the outside over a wider range of the surfaces of the first surface sheet 10 and the second surface sheet 14.

### Modified Example

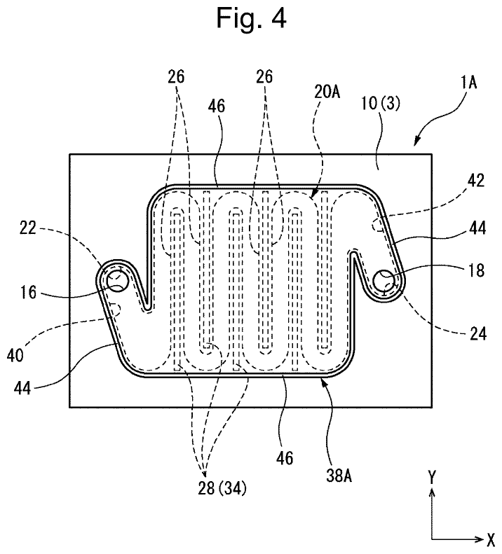

The present invention is not limited to the embodiment described above and can be appropriately modified within the scope of the gist of the present invention. For example, the flow path 20 is not limited to the aspect illustrated in FIGS. 2 and 3, and it is sufficient to have a plurality of intersecting paths 26 extending in a direction intersecting a direction connecting the inlet corresponding portion 22 and the outlet corresponding portion 24. As illustrated in FIG. 4 in which the same configurations as those in FIG. 2 are denoted by the same reference signs, a flow path 20A has an inlet-side inclined path 40 that is inclined from the inlet corresponding portion 22 toward the outlet corresponding portion 24 and extends to one side in the Y-direction. Similarly, the flow path 20A has an outlet-side inclined path 42 that is inclined from the outlet corresponding portion 24 toward the inlet corresponding portion 22 and extends to the other side in the Y-direction. The inlet-side inclined path 40 and the outlet-side inclined path 42 are connected to each other by the plurality of intersecting paths 26.

The welded part 38 is not limited to one having a rectangular shape along the outer edge of the heat exchanger 1, but may be formed along the outer edge of the flow path 20A as illustrated in FIG. 4. A welded part 38A illustrated in FIG. 4 includes an inclined portion 44 formed along the inlet-side inclined path 40 and the outlet-side inclined path 42, and a longitudinal direction portion 46 along the X-direction. Since welded part 38 has a shape along the flow path 20A, the heat exchanger 1 can reduce the pressurized area of the surface sheet 3, on which the pressure of the refrigerant acts. Therefore, in a heat exchanger 1B, deformations, in the Z-direction, of the surface sheet 3 and the flow path forming sheet 4, due to the pressure of the refrigerant, can be suppressed.

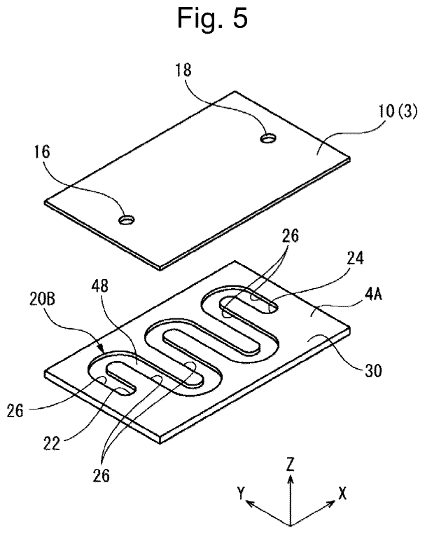

In the case of the above embodiment, the case, where the flow path forming sheet 4 includes the intermediate sheet 12 and the second surface sheet 14, has been described, but the present invention is not limited thereto. For example, as illustrated in FIG. 5 in which the same configurations as those in FIG. 2 are denoted by the same reference signs, a flow path forming sheet 4A may have a configuration in which the intermediate sheet and the second surface sheet are integrated. That is, the flow path forming sheet 4A is a rectangular plate-shaped member and has a flow path 20B on a first surface 30 facing the surface sheet 3. The flow path 20B is a groove having a bottom surface 48, and includes the inlet corresponding portion 22, the outlet corresponding portion 24, and the plurality of intersecting paths 26 extending in a direction intersecting a direction connecting the inlet corresponding portion 22 and the outlet corresponding portion 24. The flow path 20B does not penetrate in the Z-direction. The surface sheet 3 and the flow path forming sheet 4A are joined by the adhesive layer formed by the solid joining agent 28 and are continuously joined at the end portion in the X-direction and the end portion in the Y-direction, leading to the integration of them. The flow path 20B is closed on its one side in the Z-direction by the surface sheet 3 and on its the other side in the Z-direction by the bottom surface 48 of the flow path 20B.

In the case of the above embodiment, the case, where the first surface sheet 10 has the inlet 16 and the outlet 18, has been described, but the present invention is not limited thereto. For example, the first surface sheet may have an inlet and the second surface sheet may have an outlet, or the first surface sheet may have an outlet and the second surface sheet may have an inlet.

### [Method for Manufacturing Heat Exchanger]

Hereinafter, the method for manufacturing a heat exchanger will be described in more detail.

A method for manufacturing a heat exchanger according to an embodiment includes: a pre-joining process of forming a laminated body in a state in which a first member (surface sheet), a solid joining agent containing, as a main component, an amorphous thermoplastic resin that is at least one type of agent selected from the group consisting of a thermoplastic epoxy resin and a phenoxy resin, and a second member (flow path forming sheet) to be joined to the first member, are arranged in this order; and a joining process of joining the first member and the second member by heating and pressurizing the laminated body to melt the solid joining agent. In the pre-joining process, joining between the first member and the solid joining agent and between the second member and the solid joining agent is not performed, but the joining is performed in the next joining process. The solid joining agent may have tackiness, and in this case, the solid joining agent is temporarily fixed to the base material in the pre-joining process.

### <Pre-Joining Process>

In the pre-joining process, a laminated body is formed, the laminated body being in a state in which the first member, the solid joining agent containing, as a main component, an amorphous thermoplastic resin that is at least one type of agent selected from the group consisting of a thermoplastic epoxy resin and a phenoxy resin, and the second member, are arranged in this order. In the laminated body, neither the first member and the solid joining agent nor the solid joining agent and the second member are joined to each other, and the laminated body is in a state in which independent members are overlapped with each other.

“Solid” of the solid joining agent means that it is solid at room temperature, that is, it does not have fluidity under a non-pressurized state at 23° C. It is desirable that the solid joining agent be capable of retaining its outer shape without deformation for 30 days or longer under a non-pressurized condition at 23° C., and further have a property of not deteriorating.

The “main component” means a component having the highest content among the resin components in the solid joining agent and having a content of 50 mass % or more in the resin components in the solid joining agent. The solid joining agent contains the resin component in an amount of preferably 50 mass % or more, more preferably 70 mass % or more, even more preferably 80 mass % or more, and particularly preferably 90% mass % or more.

### (Solid Joining Agent)

The solid joining agent contains, as a main component, an amorphous thermoplastic resin that is at least one type of agent selected from the group consisting of a thermoplastic epoxy resin and a phenoxy resin, an epoxy equivalent of the amorphous thermoplastic resin is 1600 or more or the amorphous thermoplastic resin does not contain an epoxy group, and the heat of fusion of the amorphous thermoplastic resin is 15 J/g or less. In the known joining using a liquid adhesive, there is a risk that, if an air bubble is mixed in a joined portion or irregularities are present on the surface of a metal member, metal members to be joined may be grounded. Mixing of an air bubble into a joined portion or grounding between metal members may cause electrolytic corrosion between dissimilar metal members. In the present disclosure, a solid joining agent containing, as a main component, an amorphous thermoplastic resin that is at least one type of agent selected from the group consisting of a thermoplastic epoxy resin and a phenoxy resin is used, and hence mixing of an air bubble can be prevented and metal members can be joined to each other while absorbing the irregularities on the surface of the metal member by the thickness of the solid joining agent. Therefore, according to the present disclosure, contact between the metal members can be prevented and electrolytic corrosion, possibly occurring between dissimilar metal members, can be suppressed.

The amorphous resin in the present disclosure is a resin that has a melting point (Tm) but does not have a clear endothermic peak associated with melting or has a very small endothermic peak in measurement using a differential scanning calorimeter (DSC). The heat of fusion is calculated from the area of the endothermic peak of the DSC and the mass of the thermoplastic resin component. In a case where an inorganic filler or the like is contained in the solid joining agent, the heat of fusion is calculated from the mass of the resin component excluding the inorganic filler.

Specifically, the amorphous thermoplastic resin in the present disclosure means a resin having properties measured by the following procedure. 2 to 10 mg of a sample is weighed, placed in an aluminum pan, and heated from 23° C. to 200° C. or higher at 10° C./min using a DSC (DSC8231 available from Rigaku Corporation) to obtain a DSC curve. Then, when the heat of fusion is calculated from the area of an endothermic peak at the time of melting as determined from the DSC curve and the weighed value, those having heat of fusion of 15 J/g or less are regarded as amorphous thermoplastic resins.

From the viewpoint of sufficiently imparting the properties of the amorphous thermoplastic resin to the solid joining agent, the content of the amorphous thermoplastic resin is preferably 60 mass % or more, more preferably 70 mass % or more, even more preferably 80 mass % or more, and most preferably 90 mass % or more of the resin components in the solid joining agent.

The heat of fusion is 15 J/g or less, preferably 11 J/g or less, more preferably 7 J/g or less, even more preferably 4 J/g or less, and it is most preferable that the endothermic peak at the time of melting be the detection limit or less.

The epoxy equivalent is 1600 or more, preferably 2000 or more, more preferably 5000 or more, even more preferably 9000 or more, and it is most preferable that the epoxy equivalent be the detection limit or more and the epoxy group be not substantially detected.

When the solid joining agent is used, a rapid decrease in viscosity as seen in a known hot melt adhesive does not occur during heating, and a low viscosity (0.001 to 100 Pa-s) state is not caused even in a high temperature region exceeding 200° C. Accordingly, the solid joining agent does not flow out from the laminated body even in a molten state, and hence the thickness of the adhesive layer can be stably secured and a high adhesive force can be stably obtained. As a result, contact between the metal members can be more reliably prevented to prevent electrolytic corrosion, and a high adhesive force can be stably obtained.

The epoxy equivalent (the mass of the resin containing 1 mol of an epoxy group) in the present disclosure is a value of the epoxy equivalent of the thermoplastic epoxy resin component or the phenoxy resin component contained in the solid joining agent before joining, and is a value (in “g/eq.”) measured by the method specified in JIS K 7236:2001. Specifically, the epoxy equivalent of a resin is measured using a potentiometric titrator, using cyclohexanone as a solvent, adding a solution of tetraethylammonium bromide in acetic acid to the resin, and using 0.1 mol/L perchloric acid-acetic acid solution. With regard to a solvent-diluted product (resin varnish), the epoxy equivalent is calculated as a numerical value in terms of solid content based on a volatile component. The epoxy equivalent of a mixture of two or more resins can also be calculated from the content and the epoxy equivalent of each resin.

The melting point of the amorphous thermoplastic resin that is a main component of the solid joining agent is preferably 50° C. to 400° C., more preferably 60° C. to 350° C., and even more preferably 70° C. to 300° C. When the melting point is in a range of 50° C. to 400° C., the solid joining agent is efficiently deformed and melted by heating and effectively wet-spreads on a joint surface, so that a high adhesive force can be obtained. In the present disclosure, the melting point of the amorphous thermoplastic resin means a temperature at which the amorphous thermoplastic resin is substantially softened from a solid state to become thermoplastic and can be melted and bonded.

In a joined body containing a known thermosetting adhesive, it is difficult to disassemble a joined body, and it is difficult to separate different materials constituting the joined body for recycling (i.e., poor in recyclability). In addition, in a case of using a thermosetting adhesive, it is difficult to re-attach (i.e., poor in repairability) if a joined portion is displaced or the like in a production process of a joined body or if an adherend has a defect and needs to be replaced, resulting in lack of convenience. On the other hand, the solid joining agent can be softened and melted by heat and two adherends can be easily separated from each other, thereby providing excellent recyclability. In addition, the solid joining agent is thermoplastic, and hence, softening, melting, and curing (solidification) can be reversibly repeated, and the repairability is also excellent.

### <<Thermoplastic Epoxy Resin>>

The thermoplastic epoxy resin is preferably a polymer of (a) a bifunctional epoxy resin monomer or oligomer and (b) a bifunctional compound having two identical or different functional groups selected from the group consisting of a phenolic hydroxyl group, a carboxyl group, a mercapto group, an isocyanate group, and a cyanate ester group. When such a compound is used, a polymerization reaction for forming a linear polymer preferentially proceeds, thereby allowing formation of a thermoplastic epoxy resin having desired properties.

The (a) bifunctional epoxy resin monomer or oligomer refers to an epoxy resin monomer or oligomer having two epoxy groups in the molecule. Examples of the (a) bifunctional epoxy resin monomer or oligomer include a bisphenol A-type epoxy resin, a bisphenol F-type epoxy resin, a bifunctional phenol novolak-type epoxy resin, a bisphenol AD-type epoxy resin, a biphenyl-type epoxy resin, a bifunctional naphthalene-type epoxy resin, a bifunctional alicyclic epoxy resin, a bifunctional glycidyl ester-type epoxy resin (e.g., diglycidyl phthalate, diglycidyl tetrahydrophthalate, dimer acid diglycidyl ester), a bifunctional glycidylamine-type epoxy resins (e.g., diglycidyl aniline, diglycidyl toluidine), a bifunctional heterocyclic epoxy resin, a bifunctional diarylsulfone-type epoxy resin, a hydroquinone-type epoxy resin (e.g., hydroquinone diglycidyl ether, 2,5-di-tert-butylhydroquinone diglycidyl ether, resorcinol diglycidyl ether), a bifunctional alkyleneglycidyl ether-based compound (e.g., butanediol diglycidyl ether, butenediol diglycidyl ether, butynediol diglycidyl ether), a bifunctional glycidyl group-containing hydantoin compound (e.g., 1,3-diglycidyl-5,5-dialkylhydantoin, 1-glycidyl-3-(glycidoxyalkyl)-5,5-dialkylhydantoin), a bifunctional glycidyl group-containing siloxanes (e.g., 1,3-bis(3-glycidoxypropyl)-1,1,3,3-tetramethyldisiloxane, α,β-bis(3-glycidoxypropyl)polydimethylsiloxane), and modified products thereof. Among these, a bisphenol A-type epoxy resin, a bisphenol F-type epoxy resin, a bisphenol S-type epoxy resin, and a biphenyl-type epoxy resin are preferable in terms of reactivity and workability.

Examples of the (b) bifunctional compound having a phenolic hydroxyl group include mononuclear aromatic dihydroxy compounds having one benzene ring such as catechol, resorcinol, and hydroquinone; bisphenol compounds such as bis(4-hydroxyphenyl)propane (bisphenol A), bis(4-hydroxyphenyl)methane (bisphenol F), and bis(4-hydroxyphenyl)ethane (bisphenol AD); compounds having a condensed ring such as dihydroxynaphthalene; bifunctional phenol compounds having an allyl group such as diallylresorcinol, diallylbisphenol A, and triallyldihydroxybiphenyl; and dibutylbisphenol A.

Examples of the (b) bifunctional compound having a carboxyl group include adipic acid, succinic acid, malonic acid, cyclohexanedicarboxylic acid, phthalic acid, isophthalic acid, and terephthalic acid.

Examples of the (b) bifunctional compound having a mercapto group include ethylene glycol bisthioglycolate and ethylene glycol bisthiopropionate.

Examples of the (b) bifunctional compound having an isocyanate group include diphenylmethane diisocyanate (MDI), isophorone diisocyanate (IPDI), hexamethylene diisocyanate (HMDI), and tolylene diisocyanate (TDI).

Examples of the (b) bifunctional compound having a cyanate ester group include 2,2-bis(4-cyanatophenyl)propane, 1,1-bis(4-cyanatophenyl)ethane, and bis(4-cyanatophenyl)methane.

Among the (b) described above, a bifunctional compound having a phenolic hydroxyl group is preferable because it can form a thermoplastic polymer having suitable properties. A bifunctional compound having two phenolic hydroxyl groups and having a bisphenol structure or a biphenyl structure is preferable from the viewpoint of heat resistance and adhesiveness, and bisphenol A, bisphenol F, and bisphenol S are preferable from the viewpoint of heat resistance and cost.

In a case where the (a) is a bisphenol A-type epoxy resin, a bisphenol F-type epoxy resin, a bisphenol S-type epoxy resin, or a biphenyl-type epoxy resin and the (b) is bisphenol A, bisphenol F, or bisphenol S, the polymer obtained by polymerization of the (a) and (b) has a structure that has a main chain in which a paraphenylene structure and an ether bond constituting a main skeleton are linked by an alkylene group, and a side chain in which a hydroxyl group generated by polyaddition is arranged. A linear structure derived from the main skeleton having the paraphenylene structure and the ether bond can enhance the mechanical strength of the polymer after polymerization, and the hydroxyl group arranged in the side chain can improve the adhesion to the base material. As a result, high adhesive strength at the same level as that of a thermosetting resin can be realized while maintaining workability. Furthermore, by softening and melting with heat, recycling and repairing become possible, and recyclability and repairability that are problems in a thermosetting resin can be improved.

### <<Phenoxy Resin>>

The phenoxy resin is a polyhydroxy polyether synthesized from a bisphenol compound and epichlorohydrin, and has thermoplasticity. As a method for producing the phenoxy resin, there are known a method for directly reacting a dihydric phenol compound with epichlorohydrin and a method for subjecting a diglycidyl ether of a dihydric phenol compound and a dihydric phenol compound to an addition polymerization reaction, and the phenoxy resin may be obtained by any of these methods. In the case of a direct reaction between a dihydric phenol compound and epichlorohydrin, examples of the dihydric phenol compound include phenol compounds such as bisphenol A, bisphenol F, bisphenol S, biphenol, biphenylene diol, and fluorene diphenyl.

Among these, bisphenol A, bisphenol F, and bisphenol S are preferable from the viewpoint of cost, adhesiveness, viscosity, and heat resistance. In addition to the dihydric phenol compound, an aliphatic glycol, such as ethylene glycol, propylene glycol, or diethylene glycol, may be included in the direct reaction. These may be used alone, or in combination of two or more thereof. The phenoxy resin has a chemical structure similar to that of an epoxy resin, and has a structure that has a main chain in which a paraphenylene structure and an ether bond constituting a main skeleton are linked, and a side chain in which a hydroxyl group is arranged.

### <<Thermoplastic Epoxy Resin and Phenoxy Resin>>

Weight average molecular weights of the thermoplastic epoxy resin and the phenoxy resin are each preferably 10000 to 500000, more preferably 18000 to 300000, and even more preferably 20000 to 200000 as a value measured by gel permeation chromatography (GPC) and calibrated with polystyrene. The weight average molecular weight is a value calibrated with standard polystyrene calculated from an elution peak position detected by GPC. When the weight average molecular weight is in the above range, thermoplasticity and heat resistance are well balanced, and hence, it is possible to efficiently form a joined body by melting and it is also possible to enhance the heat resistance of the joined body. When the weight average molecular weight is 10000 or more, heat resistance is excellent, and when the weight average molecular weight is 500000 or less, viscosity at the time of melting is low and adhesiveness is high.

<<Method for producing Solid Joining Agent>>

A method for producing the solid joining agent is not particularly limited. For example, the solid joining agent can be produced by heating and polymerizing a monomer or an oligomer of a bifunctional epoxy compound. A solvent may be added to reduce viscosity during polymerization to facilitate stirring. In a case where a solvent is added, it is necessary to remove the solvent, and the solid joining agent may be obtained by performing drying and/or polymerization on a release film or the like.

As needed, another additive may be blended to the solid joining agent as long as the effects of the present invention are not impaired. A blending amount of the additive with respect to the total amount of the amorphous thermoplastic resin is preferably 50 vol. % or less, more preferably 30 vol. % or less, even more preferably 20 vol. % or less, and most preferably 10 vol. % or less. In the present disclosure, the vol. % of the additive represents a volume ratio of the additive contained before the polymerization of the monomer or oligomer of the bifunctional epoxy compound based on the volume of the total amount of the amorphous thermoplastic resin, and the volume of the additive can be determined by dividing the mass of the contained additive by the true specific gravity of the additive.

Examples of the additive include a viscosity modifier, an inorganic filler, an organic filler (resin powder), an antifoaming agent, a coupling agent such as a silane coupling agent, and a pigment. These additives may be used alone, or in combination of two or more thereof. Examples of the viscosity modifier include a reactive diluent. Examples of the inorganic filler include spherical fused silica, metal powders of metals such as iron, silica sand, talc, calcium carbonate, mica, acid clay, diatomaceous earth, kaolin, quartz, titanium oxide, silica, phenol resin microballoon, and glass balloon.

The solid joining agent thus obtained has a low content of unreacted monomers or terminal epoxy groups or substantially no unreacted monomer or terminal epoxy group. Hence, the solid joining agent is excellent in storage stability and can be stored for a long period of time at room temperature.

The form of the solid joining agent before melting is not particularly limited, and preferably has any shape selected from the group consisting of a film, a rod, a pellet, and a powder. At least one side of the outer shape of the solid joining agent is preferably 5 mm or less, more preferably 3 mm or less, even more preferably 1 mm or less, particularly preferably 0.5 mm or less, and most preferably 0.3 mm or less. When the solid joining agent whose at least one side of the outer shape is 5 mm or less is sandwiched between the first member and the second member and is heated and pressurized, the solid joining agent efficiently spreads on a bonding surface, so that a high adhesive force can be obtained.

It is more preferable that the solid joining agent before melting have a film shape. While reliably holding the metal members to be joined at a predetermined interval over the entire joint surface, the film-shaped solid joining agent can join these metal members to each other. Therefore, the film-shaped solid joining agent is particularly advantageous for preventing electrolytic corrosion. The thickness of the film-shaped solid joining agent is preferably 10 μm to 5 mm, more preferably 20 μm to 3 mm, and even more preferably 30 μm to 0.5 mm. When the thickness of the film-shaped solid joining agent is set to 10 μm or more, electrolytic corrosion between the first member and the second member can be more reliably prevented, and an adhesive force can be ensured. When the thickness of the film-shaped solid joining agent is set to 5 mm or less, the adhesive force, in the shear direction, of the joint surface can be increased.

The solid joining agent may have tackiness within a range that does not impair the adhesive force and the heat resistance. In this case, the solid joining agent can be temporarily fixed to the base material in the laminated body preparation process.

### <Joining Process>

In the joining process, the laminated body is heated and pressurized to melt the solid joining agent, and then the temperature is lowered to solidify the solid joining agent, thereby joining the first member and the second member.

The temperature in the heating and pressurization is preferably 100° C. to 400° C., more preferably 120° C. to 350° C., and even more preferably 150° C. to 300° C. When heating is performed at 100° C. to 400° C., the solid joining agent is efficiently deformed and melted to effectively wet-spread on the joint surface, and hence a high adhesive force can be obtained.

The pressure in the heating and pressurization is preferably 0.01 MPa to 20 MPa, more preferably 0.1 MPa to 10 MPa, and even more preferably 0.2 MPa to 5 MPa. The pressure here means an average pressure at the joint surfaces of the first member and the second member. When the pressurization is performed at 0.01 MPa to 20 MPa, the solid joining agent is efficiently deformed to effectively wet-spread on the joint surface, and hence a high adhesive force can be obtained. In a case where at least one of the first member or the second member contains a thermoplastic resin in the joint surface, the solid joining agent and the thermoplastic resin of the member can be made compatible with each other by pressurization at 0.01 MPa to 20 MPa, so that a high adhesive force can be obtained.

The thermoplastic epoxy resin and the phenoxy resin, which are the main components of the solid joining agent, have a low cohesive force in the resin and have a hydroxyl group, and hence have strong interaction with the base material, and different materials can be joined with an adhesive force higher than that of a known crystalline hot melt adhesive.

The joining between the first member and the second member utilizes phase changes (solid-liquid-solid) of the solid joining agent and does not involve a chemical reaction, and hence the joining can be completed in a shorter time than that of a known thermosetting epoxy resin.

The thickness of the solid joining agent after joining is preferably 10 μm to 5 mm, more preferably 20 μm to 3 mm, and even more preferably 30 μm to 0.5 mm. When the thickness of the solid joining agent after joining is set to 10 μm or more, electrolytic corrosion between the first member and the second member can be more reliably prevented, and an adhesive force can be ensured. When the thickness of the solid joining agent after joining is set to 5 mm or less, the adhesive force, in the shear direction, of the joint surface is increased, and the flow path of the heat exchanger can be more reliably held.

### [Heat Exchanger (Joined Body 1)]

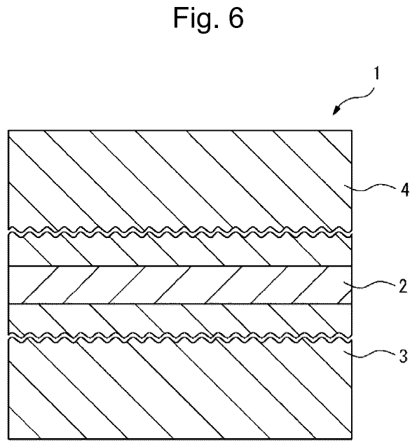

FIG. 6 is a schematic cross-sectional view of a state in which the first member 3 and the second member 4 are joined to each other via the solid joining agent, and is a view illustrating a joined portion between the surface sheet and the flow path forming sheet illustrated, for example, in FIG. 1. In the joined body 1 illustrated in FIG. 6, the first member 3 and the second member 4 are joined and integrated via the adhesive layer 2 in which the solid joining agent is melted and then solidified, and the joined body 1 of the first member 3 and the second member 4 exhibits excellent joining strength. The joining strength is affected by many factors such as the thickness of the adhesive layer, the molecular weight and chemical structure of the polymer constituting the adhesive, mechanical properties, and viscoelastic properties, in addition to the strength of interfacial interaction acting between the adhesive layer and the base material. Accordingly, although the details of the mechanism by which the joined body 1 of the present disclosure exhibits excellent joining strength are not clear, it is presumed that the main factors are the low cohesive force of the amorphous thermoplastic resin constituting the adhesive layer and the presence of hydroxyl groups in the resin to form chemical bonds or intermolecular forces, such as hydrogen bonds and van der Waals forces, at the interface between the adhesive layer and the first member and at the interface between the adhesive layer and the second member. However, in the joined body 1, the state or property of the interface of the joined body 1 is derived from an extremely thin chemical structure having a thickness of a nanometer level or less, and hence it is difficult to analyze the state or property. It is impossible or impractical in the current technology to distinguishably express the joined body 1 and a joined body 1 not containing the solid joining agent of the present disclosure by identifying the state or property of the interface of the joined body 1 of the present disclosure.

The heat exchanger of the present disclosure in which the adhesive layer contains an amorphous thermoplastic resin is excellent in recyclability and repairability, and can be easily disassembled into the first member and the second member, that is, the surface sheet and the flow path forming sheet by heating the joined body 1.

### EXAMPLES

Test examples and comparative test examples relating to the present invention will be described below, but the present invention is not limited thereto. In the following examples, the first member and the second member are collectively referred to as a joining base material.

### <Joining Base Material>

The following joining base materials were used.

### (1) First Member

### <<Aluminum>>

The surface of an aluminum alloy A6061-T6 (Young's modulus: 68.3 GPa) was blasted to obtain a test piece having a width of 18 mm, a length of 45 mm, and a thickness of 1.5 mm.

### (2) Second Member

### <<PC (Polycarbonate)>>

121R available from SABIC was injection-molded to obtain a test piece having a width of 10 mm, a length of 45 mm, and a thickness of 3 mm. It was used without surface treatment.

### <<Aluminum>>

The surface of an aluminum alloy A6061-T6 (Young's modulus: 68.3 GPa) was blasted to obtain a test piece having a width of 10 mm, a length of 45 mm, and a thickness of 3 mm.

### <Weight Average Molecular Weights, Heat of Fusion, and Epoxy Equivalents of Thermoplastic Epoxy Resin and Phenoxy Resin>

The weight average molecular weight, heat of fusion, and epoxy equivalent of each of the thermoplastic epoxy resin and the phenoxy resin were measured by the following procedures.

### (Weight Average Molecular Weight)

The thermoplastic epoxy resin and the phenoxy resin were each dissolved in tetrahydrofuran and measurement was performed using Prominence 501 (available from Showa Science Co., Ltd., Detector: Shodex (trade name) RI-501 (available from Showa Denko K.K.)) under the following conditions.

Column: LF-804×2 available from Showa Denko K.K.

Column temperature: 40° C.

Sample: 0.4 mass % resin solution in tetrahydrofuran

Flow rate: 1 mL/min

Eluent: tetrahydrofuran

Calibration method: conversion by standard polystyrene

### (Heat of Fusion)

The thermoplastic epoxy resin and the phenoxy resin were weighed from 2 to 10 mg, placed in an aluminum pan, and heated from 23° C. to 200° C. at 10° C./min using a DSC (DSC8231 available from Rigaku Corporation) to obtain a DSC curve. The heat of fusion was calculated from the area of an endothermic peak at the time of melting in the obtained DSC curve and the weighed value.

### (Epoxy Equivalent)

A measured value obtained in accordance with JIS K 7236:2001 was converted into a value as a resin solid content. In a case of a simple mixture without reaction, it was calculated from the epoxy equivalent and content of each mixed component.

### Test Example 1

### (Solid Joining Agent P-1)

Into a reactor equipped with a stirrer, a reflux condenser, a gas inlet tube, and a thermometer, 203 g (1.0 equivalent) of jER (trade name) 1007 (available from Mitsubishi Chemical Corporation, bisphenol A-type epoxy resin, weight average molecular weight: about 10000), 12.5 g (1.0 equivalent) of bisphenol S, 2.4 g of triphenylphosphine, and 1000 g of methylethylketone were charged and heated to 100° C. while stirring under a nitrogen gas atmosphere. After visually confirming that they are dissolved, the mixture was cooled to 40° C. to obtain a resin composition having a solid content of about 20 mass %. The solvent was removed from the resin composition, and the resin component was heated at 160° C. for 2 hours to obtain a film-shaped solid joining agent (P-1) having a solid content of 100 mass % and a thickness of 100 μm. The weight average molecular weight was about 37000. The epoxy equivalent was the detection limit or more. No peak of heat of fusion was detected in the DSC.

### (Joined Body)

The following two types were prepared as the joined body. For open time evaluation, a joined body for open time evaluation was also prepared in the same procedure as in the following “metal/metal” except that a solid joining agent was placed on the aluminum base material (first member) and allowed to stand for 3 days, and then the aluminum base material (second member) was placed thereon.

### <<Metal/metal>>

The solid joining agent P-1 cut into a size of 10×15 mm was placed on the aluminum base material (first member), and then the aluminum base material (second member) was immediately placed thereon. An overlap between these base materials was set to a width of 10 mm and a depth of 5 mm. The solid joining agent P-1 was arranged to cover the entire overlapping region between the base materials. That is, the first member and the second member were not in direct contact with each other, and the solid joining agent was interposed therebetween to prepare an unjoined laminated body.

The metal was heated by high-frequency induction using a high-frequency induction welding machine (available from Seidensha Electronics Co., Ltd., Oscillator UH-2.5K, Press JIIP30S), and the test pieces were joined to each other by heating and pressurization. A force for pressurization was 110 N (pressure 2.2 MPa) and an oscillation frequency was 900 kHz. The oscillation time was 5 seconds.

### <<Metal/resin>>

A joined body was obtained in the same manner as in the <<Metal/metal joined body except that the aluminum base material was used as the first member and the PC base material was used as the second member.

### Test Example 2

### (Solid Joining Agent P-2)

Into a reactor equipped with a stirrer, a reflux condenser, a gas inlet tube, and a thermometer, 20 g of Enototo (trade name) YP-50S (available from NIPPON STEEL Chemical & Material CO., LTD., phenoxy resin, weight average molecular weight: about 50000) and 80 g of cyclohexanone were charged and heated to 60° C. while stirring, visually confirmed to be dissolved, and cooled to 40° C. to obtain a resin composition having a solid content of 20 mass %. The solvent was removed from the resin composition to obtain a film-shaped solid joining agent (P-2) having a solid content of 100 mass % and a thickness of 100 μm. The weight average molecular weight was 50000, and the epoxy equivalent was the detection limit or more. No peak of heat of fusion was detected in the DSC.

### (Joined Body)

A joined body listed in Table 1 and a joined body for open time evaluation were prepared in the same manner as in Test Example 1 except that P-2 was used as the solid joining agent.

### Test Example 3

### (Solid Joining Agent P-3)

A solid joining agent (P-3) was obtained by mixing the resin composition P-2 and a crystalline epoxy resin YSLV-80XY (available from NIPPON STEEL Chemical & Material CO., LTD.) at a mass ratio of 98:2. The weight average molecular weight was 36000, the epoxy equivalent was 9600 g/eq, and the heat of fusion was 2 J/g.

### (Joined Body)

A joined body listed in Table 1 and a joined body for open time evaluation were prepared in the same manner as in Test Example 1 except that P-3 was used as the solid joining agent.

### Test Example 4

### (Solid Joining Agent P-4)

A solid joining agent (P-4) was obtained by mixing the resin composition P-2 and a crystalline epoxy resin YSLV-80XY (available from NIPPON STEEL Chemical & Material CO., LTD.) at a mass ratio of 94:6. The weight average molecular weight was 35000, the epoxy equivalent was 2100 g/eq, and the heat of fusion was 4 J/g.

### (Joined Body)

A joined body listed in Table 1 and a joined body for open time evaluation were prepared in the same manner as in Test Example 1 except that P-4 was used as the solid joining agent.

### Test Example 5

### (Solid Joining Agent P-5)

A solid joining agent (P-5) was obtained by mixing the resin composition P-2 and a crystalline epoxy resin YSLV-80XY (available from NIPPON STEEL Chemical & Material CO., LTD.) at a mass ratio of 89:11. The weight average molecular weight was 33000, the epoxy equivalent was 1745 g/eq, and the heat of fusion was 11 J/g.

### (Joined Body)

A joined body listed in Table 1 and a joined body for open time evaluation were prepared in the same manner as in Test Example 1 except that P-5 was used as the solid joining agent.

### Test Example 6

### (Solid Joining Agent P-6)

Into a reactor equipped with a stirrer, a reflux condenser, a gas inlet tube, and a thermometer, 203 g (1.0 equivalent) of jER (trade name) 1007 (available from Mitsubishi Chemical Corporation, bisphenol A-type epoxy resin, molecular weight: about 4060), 12.5 g (0.6 equivalent) of bisphenol S (molecular weight: 250), 2.4 g of triphenylphosphine, and 1000 g of methylethylketone were charged and heated to 100° C. while stirring under a nitrogen gas atmosphere. After visually confirming that they are dissolved, the mixture was cooled to 40° C. to obtain a resin composition having a solid content of about 20 mass %. The solvent was removed from the resin composition, and the resin component was heated at 160° C. for 2 hours to obtain a film-shaped solid joining agent (P-6) having a solid content of 100 mass % and a thickness of 100 μm. The weight average molecular weight was about 30000, and the epoxy equivalent was the detection limit or more. No peak of heat of fusion was detected in the DSC.

### (Joined Body)

A joined body listed in Table 1 and a joined body for open time evaluation were prepared in the same manner as in Test Example 1 except that P-6 was used as the solid joining agent.

### Comparative Test Example 1

### (Solid Joining Agent Q-1)

Two liquids of a thermosetting liquid epoxy adhesive E-250 (available from Konishi Co., Ltd., two-liquid type of bisphenol-type epoxy resin and amine curing agent) were mixed, applied to a release film, cured at 100° C. for 1 hour, then cooled, and peeled off from the release film to obtain a 100 μm-thick film-shaped solid joining agent (Q-1). No peak of heat of fusion was detected in the DSC. The solid joining agent was insoluble in the solvent, and hence it was impossible to measure the epoxy equivalent and the weight average molecular weight.

### (Joined Body)

A joined body listed in Table 1 and a joined body for open time evaluation were prepared in the same manner as in Test Example 1 except that Q-1 was used as the solid joining agent.

### Comparative Test Example 2

### (Solid Joining Agent Q-2)

An amorphous polycarbonate film (Iupilon (trade name) FE2000, available from Mitsubishi Engineering-Plastics Corporation, thickness: 100 μm) was used as a solid joining agent Q-2. No peak of heat of fusion was detected in the DSC.

### (Joined Body)

A joined body listed in Table 1 and a joined body for open time evaluation were prepared in the same manner as in Test Example 1 except that Q-2 was used as the solid joining agent.

### Comparative Test Example 3

### (Solid Joining Agent Q-3)

A crystalline epoxy resin YSLV-80XY (available from NIPPON STEEL Chemical & Material CO., LTD.) was used as a solid joining agent (Q-3). The epoxy equivalent was 192 g/eq. The weight average molecular weight was 340. The heat of fusion was 70 J/g.

### (Joined Body)

A joined body listed in Table 1 and a joined body for open time evaluation were prepared in the same manner as in Test Example 1 except that Q-3 was used as the solid joining agent.

### Comparative Test Example 4

### (Joined Body)

Two liquids of a thermosetting liquid epoxy adhesive E-250 (available from Konishi Co., Ltd., two-liquid type of bisphenol-type epoxy resin and amine curing agent) were mixed, applied to each of the same first member and second member as in Test Example 1, and bonded to each other within 1 minute. Thereafter, the bonded body was allowed to stand in an oven at 100° C. for 1 hour in a state of being fixed with a clip to cure the adhesive component, and then cooled to room temperature to prepare the joined body listed in Table 1. A joined body for open time evaluation was also prepared in the same manner as described above except that the thermosetting liquid epoxy adhesive E-250 was applied to each of the first member and the second member, and then the first member and the second member were allowed to stand for 3 days and then bonded to each other.

### Comparative Test Example 5

Into a flask, 203 g (1.0 equivalent) of jER (trade name) 1007 (available from Mitsubishi Chemical Corporation, bisphenol A-type epoxy resin, weight average molecular weight: about 10000), 12.5 g (1.0 equivalent) of bisphenol S, 2.4 g of triphenylphosphine, and 1000 g of methylethylketone were charged, and stirred at normal temperature to obtain a liquid resin composition having a solid content of about 20 mass %. The liquid resin composition was applied onto the same second member as in Test Example 1 by bar coating, dried at room temperature for 30 minutes, and then allowed to stand in an oven at 160° C. for 2 hours to form a solid coating layer of a thermoplastic epoxy resin polymer having a thickness of 100 μm on the surface of the second member. The weight average molecular weight of the coating layer was about 40000. The epoxy equivalent was the detection limit or more. No peak of heat of fusion was detected in the DSC.

### (Joined Body)

A joined body listed in Table 1 was prepared in the same manner as in Test Example 1 except that the first member was directly placed on the second member having the coating layer. For open time evaluation, a joined body for open time evaluation was also prepared in the same manner as described above except that a coating layer of a thermoplastic epoxy resin polymer was formed on the surface of the second member, then allowed to stand for 3 days, and then stacked with the first member.

### Comparative Test Example 6

Into a reactor equipped with a stirrer, a reflux condenser, a gas inlet tube, and a thermometer, 20 g of Phenototo (trade name) YP-50S (available from NIPPON STEEL Chemical & Material CO., LTD., phenoxy resin, weight average molecular weight: about 50000) and 80 g of cyclohexanone were charged and heated to 60° C. while stirring, visually confirmed to be dissolved, and cooled to 40° C. to obtain a liquid resin composition having a solid content of 20 mass %. The liquid resin composition was applied onto the same second member as in Test Example 1 by bar coating, and was allowed to stand in an oven at 70° C. for 30 minutes to form a phenoxy resin coating layer having a thickness of 100 μm on the surface of the second member. The weight average molecular weight of the coating layer was about 50000. The epoxy equivalent was the detection limit or more. No peak of heat of fusion was detected in the DSC.

### (Joined Body)

A joined body listed in Table 1 was prepared in the same manner as in Test Example 1 except that the first member was directly placed on the second member having the phenoxy resin coating layer. For open time evaluation, a joined body for open time evaluation was also prepared in the same manner as described above except that the phenoxy resin coating layer was formed on the surface of the second member, then allowed to stand for 3 days, and then stacked with the first member.

### Comparative Test Example 7

### (Joined Body)

A joined body listed in Table 1 and a joined body for open time evaluation were prepared in the same manner as in Test Example 1 except that a crystalline polyamide-based hot melt adhesive film NT-120 (available from Nihon Matai Co., Ltd., thickness: 100 μm) was used as the solid joining agent. The heat of fusion was 60 J/g.

### [Shear Adhesive Force]

The joined bodies obtained in Test Examples 1 to 6 and Comparative Test Examples 1 to 7 were allowed to stand at a measurement temperature (23° C.) for 30 minutes or longer, and then subjected to a tensile shear adhesive strength test in an atmosphere of 23° C. in accordance with ISO19095 using a tensile tester (universal tester autograph “AG-X plus” (available from Shimadzu Corporation); load cell: 10 kN, tensile speed: 10 mm/min) to measure joining strength. The measurement results are listed in Table 1.

### [Joining Process Time]

The joining process time was measured as follows. The time from a start point to an end point was measured with the time when the joining agent first came into contact with one or both of the base materials constituting the joined body as the start point and the time when the preparation of the joined body was completed as the end point. As for heating and pressurization times, the respective numerical values of the joined bodies listed in Table 1 were averaged.

### [Recyclability]

The joined body listed in Table 1 was placed on a hotplate at 200° C. and heated for 1 minute, and then recyclability was judged on the basis of whether the joined body could be easily peeled off with a force of 1 N or less. It was evaluated as good (OK) if it could be peeled off, and it was evaluated as unsuitable (NG) if it could not be peeled off

### [Repairability]

After the tensile shear strength test at 23° C., among the test pieces of aluminum whose joint surfaces were fractured (the layer of the joined solid remained on the surface of the first member or the second member or the surfaces of both of them), the first member was placed on the second member and a joined body was prepared in the same manner as in Test Example 1 to obtain a repair joined body. The shear adhesive force of the repair joined body at 23° C. was measured in the same manner as in the test method. When the shear adhesive force was 80% or more of the first shear adhesive force, repairability was evaluated as good (OK), and when the shear adhesive force was less than 80%, repairability was evaluated as unsuitable (NG).

### [Open Time Evaluation]

The joined body for open time evaluation was used to perform the tensile shear adhesive strength test at 23° C. As compared with the test pieces prepared by the method of Test Examples and Comparative Test Examples, when the shear adhesive force was 80% or more, open time evaluation was determined as good (OK), and when the shear adhesive force was less than 80%, it was determined as unsuitable (NG). The open time evaluation being good (OK) means that the open time is long and convenience is excellent.

TABLE 1

| | | | Test | Test | Test | Test | Test | Test |
|---|---|---|---|---|---|---|---|---|
| | | | Example 1 | Example 2 | Example 3 | Example 4 | Example 5 | Example 6 |
| Properties of joining agent | | Form of | Film | Film | Film | Film | Film | Film |
| | | joining agent | | | | | | |
| | | Resin main | Thermo- | Phenoxy | Thermo- | Thermo- | Thermo- | Thermo- |
| | | component | plastic | resin | plastic | plastic | plastic | plastic |
| | | | epoxy resin | | epoxy resin | epoxy resin | epoxy resin | epoxy resin |
| | | Weight | 37,000 | 50,000 | 36,000 | 35,000 | 33,000 | 30,000 |
| | | average | | | | | | |
| | | molecular | | | | | | |
| | | weight | | | | | | |
| | | Heat of | Fusion | Fusion | 2 | 4 | 11 | Fusion |
| | | fusion [J/g] | peak | peak | | | | peak |
| | | | None | None | | | | None |
| | | Epoxy | Detection | Detection | 9,600 | 2,100 | 1,745 | Detection |
| | | equivalent | limit | limit | | | | limit |
| | | [g/eq] | or more | or more | | | | or more |
| Adhesive | 23° C. Shear | Metal/metal | 21 | 22 | 22 | 20 | 15 | 17 |
| force | adhesive force [MPa] | | | | | | | |
| | 23° C. Shear | Metal/resin | 25 | 19 | 23 | 22 | 23 | 15 |
| | adhesive force [MPa] | | | | | | | |

| | | | | | | | |
|---|---|---|---|---|---|---|---|
| Convenience | Joining process time | 3.5 seconds | 3.5 seconds | 3.5 seconds | 3.5 seconds | 3.5 seconds | 3.5 seconds |
| | Recyclability | OK | OK | OK | OK | OK | OK |
| | Repairability | OK | OK | OK | OK | OK | OK |
| | Open time evaluation | OK | OK | OK | OK | OK | OK |

| | | | Compar- | Compar- | Compar- | Compar- | Compar- | Compar- | Compar- |
|---|---|---|---|---|---|---|---|---|---|
| | | | ative | ative | ative | ative | ative | ative | ative |
| | | | Test | Test | Test | Test | Test | Test | Test |
| | | | Example 1 | Example 2 | Example 3 | Example 4 | Example 5 | Example 6 | Example 7 |
| Properties of joining | | Form of | Film | Film | Film | Liquid | Coating | Coating | Film |
| agent | | joining | | | | | layer | layer | |
| | | agent | | | | | | | |
| | | Resin main | Thermo- | Poly- | Epoxy | Thermo- | Thermo- | Phenoxy | Poly- |
| | | component | setting | carbonate | resin | setting | plastic | resin | amide |
| | | | epoxy | | | epoxy | epoxy | | |
| | | | resin | | | resin | resin | | |
| | | Weight | — | — | 340 | — | 40,000 | 50,000 | — |
| | | average | | | | | | | |
| | | molecular | | | | | | | |
| | | weight | | | | | | | |
| | | Heat of | Fusion | Fusion | 70 | Fusion | Fusion | Fusion | 60 |
| | | fusion | peak | peak | | peak | peak | peak | |
| | | [J/g] | None | None | | None | None | None | |
| | | Epoxy | — | — | 192 | — | Detection | Detection | — |
| | | equivalent | | | | | limit | limit | |
| | | [g/eq] | | | | | or more | or more | |
| Adhesive | 23° C. | Metal/metal | 0 | 1 | 2 | 15 | 20 | 20 | 6 |
| force | Shear | | | | | | | | |
| | adhesive | | | | | | | | |
| | force [MPa] | | | | | | | | |
| | 23° C. | Metal/resin | 1 | 3 | 2 | 15 | 20 | 21 | 1 |
| | Shear | | | | | | | | |
| | adhesive | | | | | | | | |
| | force [MPa] | | | | | | | | |

| | | | | | | | | |
|---|---|---|---|---|---|---|---|---|
| Convenience | Joining process time | 3.5 seconds | 3.5 seconds | 3.5 seconds | 70 min | 150 min | 32 min | 3.5 seconds |
| | Recyclability | NG | OK | OK | NG | OK | OK | OK |
| | Repairability | NG | OK | OK | NG | OK | OK | OK |
| | Open time evaluation | NG | OK | OK | NG | OK | OK | OK |

According to the present invention, a heat exchanger, in which the surface sheet (first member) and the flow path forming sheet (second member) are firmly joined, can be manufactured in a short joining process time and a long open time.

### INDUSTRIAL APPLICABILITY

The present invention is applicable to a method for manufacturing a heat exchanger.

### REFERENCE SIGNS LIST

1 Joined body (Heat exchanger)
1A Heat exchanger
2 Adhesive layer
3 First member (Surface sheet)
4 Second member (Flow path forming sheet)
4A Flow path forming sheet
10 First surface sheet
12 Intermediate sheet
14 Second surface sheet
16 Inlet
18 Outlet
20, 20A, 20B Flow path
22 Inlet corresponding portion
24 Outlet corresponding portion
26 Intersecting path
28 Solid joining agent
30 First surface (surface)
32 Second surface
34 First solid joining agent
36 Second solid joining agent
38, 38A Welded part
40 Inlet-side inclined path
42 Outlet-side inclined path
44 Inclined portion
46 Longitudinal direction portion
48 Bottom surface

1. A method for manufacturing a heat exchanger, comprising:
a pre-joining process of preparing a laminated body in a state in which a surface sheet, a solid joining agent containing, as a main component, an amorphous thermoplastic resin that is at least one type of agent selected from the group consisting of a thermoplastic epoxy resin and a phenoxy resin, and a flow path forming sheet having a flow path on a surface facing the surface sheet, are arranged in this order; and
a joining process of joining the surface sheet and the flow path forming sheet by heating and pressurizing the laminated body to melt the solid joining agent, wherein
an epoxy equivalent of the amorphous thermoplastic resin is 1600 or more or the amorphous thermoplastic resin does not contain an epoxy group, and heat of fusion of the amorphous thermoplastic resin is 15 J/g or less.

2. The method for manufacturing a heat exchanger according to claim 1, wherein the heating and pressurizing are performed under conditions of 100° C. to 400° C. and 0.01 MPa to 20 MPa.

3. The method for manufacturing a heat exchanger according to claim 1, wherein the solid joining agent before melting has a shape selected from the group consisting of a film, a rod, a pellet, and a powder.

4. The method for manufacturing a heat exchanger according to claim 1, wherein materials of the surface sheet and the flow path forming sheet are metals.

5. A heat exchanger comprising:
a surface sheet;
a flow path forming sheet; and
an adhesive layer joining the surface sheet and the flow path forming sheet, wherein
the adhesive layer contains a solid joining agent containing, as a main component, an amorphous thermoplastic resin that is at least one type of agent selected from the group consisting of a thermoplastic epoxy resin and a phenoxy resin, an epoxy equivalent of the amorphous thermoplastic resin is 1,600 or more or the amorphous thermoplastic resin does not contain an epoxy group, and heat of fusion of the amorphous thermoplastic resin is 15 J/g or less.

6. The heat exchanger according to claim 5, wherein materials of the surface sheet and the flow path forming sheet are metals.

7. The heat exchanger according to claim 5, wherein:
the surface sheet has an inlet and an outlet, and the flow path forming sheet has a flow path on a surface facing the surface sheet;
the flow path includes
an inlet corresponding portion connected to the inlet, and an outlet corresponding portion connected to the outlet, and
a plurality of intersecting paths extending in a direction intersecting a direction connecting the inlet corresponding portion and the outlet corresponding portion;
the surface sheet and the flow path forming sheet are joined to each other by welding so as to surround an outer side of the flow path; and
the adhesive layer is provided at at least one of positions along the plurality of intersecting paths.

8. The heat exchanger according to claim 7, wherein
the surface sheet includes a first surface sheet and a second surface sheet;
the flow path penetrates the flow path forming sheet in a thickness direction;
in order of, the first surface sheet, the flow path forming sheet, and the second surface sheet are sequentially provided in the thickness direction; and
the inlet and the outlet are provided in the first surface sheet.

9. The heat exchanger according to claim 7, wherein
the surface sheet includes a first surface sheet and a second surface sheet;
the flow path penetrates the flow path forming sheet in a thickness direction;
in order of, the first surface sheet, the flow path forming sheet, and the second surface sheet are sequentially provided in the thickness direction; and
the inlet is provided in the first surface sheet, and the outlet is provided in the second surface sheet.
